(19) United States
(12) Patent Application Publication
(10) Pub. No.: US 2007/0080802 A1
(43) Pub. Date: Apr. 12, 2007

(54) Tamper & intrusion detection device

(76) Inventors: John Malcolm Cockburn, Richmond (CA); Robin Wald, Surrey (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 11/207,734

(22) Filed: Aug. 22, 2005

(51) Int. Cl. E05B 45/06

(52) U.S. Cl. 340/542

(57) ABSTRACT

A tamper and intrusion detection device comprising a securing element received in an opening to contact a switch assembly, wherein insertion of the securing element places a switch of the switch assembly in a closed position, and removal of the securing element places the switch in an open position. The switch assembly is in communication with a conducting electrical circuit, such that the circuit conducts electricity when the switch is closed and the circuit does not conduct electricity when the switch is open. Opening of the switch results in the creation of an alarm event, which may result in the triggering of one or more of an audio device, a visual device, a paging device, or a logging device.

### TECHNICAL FIELD

This invention relates to security and alarm systems, and in particular to devices for monitoring opening of a closure.

### BACKGROUND

It is often desirable to secure doors, access hatches, gates, containers and other closures to prevent and/or detect unauthorized opening thereof. Traditional methods for preventing unauthorized opening of closures involve the use of locks. However, locks have the drawback of requiring the user to carry a key or memorize combination sequences. Further, locks are susceptible to undetected tampering if unauthorized persons remove the lock, gain access to the closure, and re-attach the lock.

It is also desirable to provide means for preventing un-authorized access to fuel contained within fuel tankers. Unauthorized persons may not only steal the fuel, but may also replace the contents with water or some other liquid, in order to make the liquid level appear correct at the final destination. When a fuel tanker reaches its destination, the contents of the tanker would normally be added to a larger reservoir, thereby contaminating the entire reservoir. Thus, there is a need for intrusion detection devices that can provide a warning if there has been unauthorized access to the contents of a fuel tanker.

Optical and other types of sensors are sometimes used on vehicles such as fuel tankers in order to monitor fluid levels in the tanker. However, in some instances, unauthorized users may remove the sensor in order to siphon fluid from the tanker through the resultant opening. There is therefore a need for a device capable of monitoring such sensors, in order to provide a warning if someone removes or tampers with the sensor.

U.S. Pat. No. 5,831,531 to Tuttle discloses an example prior art system which incorporates a trip-wire or magnetic circuit associated with a container. If continuity of the circuit is disabled by a forced entry into the container, electrical detection means alert the owner or a monitoring station.

There remains a need for robust devices capable providing an indication that a closure has been accessed.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a device for monitoring opening of a closure. The device comprises a securing element and a switch assembly. The switch assembly comprises a switch and an opening positioned to receive the securing element. The switch is configured to be in a first position when the securing element is inserted into the opening and in a second position when the securing element is not inserted into the opening. The closure cannot be opened while the securing element is within the opening of the switch assembly.

Another aspect of the invention provides a method for monitoring opening of a closure having first and second portions which are moveable with respect to one another to allow access to an area secured by the closure. The method comprises providing a device comprising a securing element and a switch assembly including a switch and an opening positioned to receive the securing element, the switch configured to be in a first position when the securing element is inserted into the opening and in a second position when the securing element is not inserted into the opening, attaching the securing element to the first portion of the closure, attaching the switch assembly to the second portion of the closure, and, inserting the securing element into the opening of the switch assembly, such that the closure cannot be accessed without removing the securing element from the opening of the switch assembly.

Another aspect of the invention provides a method for monitoring opening of a closure having first and second portions which are moveable with respect to one another to allow opening of the closure, and locking means for holding the first and second portions of the closure in a closed position. The method comprises providing a device comprising a securing element and a switch assembly including a switch and an opening. positioned to receive the securing element, the switch configured to be in a first position when the securing element is inserted into the opening and in a second position when the securing element is not inserted into the opening, and, inserting the securing element through the locking means and into the opening of the switch assembly, whereby the closure cannot be accessed without removing the securing element from the opening of the switch assembly.

In addition to the exemplary aspects and embodiments described above, further aspects and embodiments will become apparent by reference to the drawings and by study of the following detailed descriptions.

### BRIEF DESCRIPTION OF DRAWINGS

Example non-limiting embodiments are illustrated in the appended drawings. It is intended that the embodiments and figures disclosed herein are to be considered illustrative rather than restrictive.

In drawings which illustrate non-limiting embodiments of the invention:

FIG. 1 shows a tamper and intrusion detection device according to one embodiment of the invention;

FIG. 2 shows the tamper and intrusion detection device of FIG. 1 used to monitor opening of a hatch having locking means;

FIG. 3 shows the tamper and intrusion detection device of FIG. 1 used to monitor opening of a hatch without locking means;

FIG. 4 shows a tamper and intrusion detection device according to another embodiment of the invention;

FIG. 5 shows the tamper and intrusion detection device of FIG. 4 used to monitor opening of a container having two adjacent access doors;

FIG. 6 shows the tamper and intrusion detection device of FIG. 1 used to monitor opening of a man-hole cover;

FIG. 7 shows the tamper and intrusion detection device of FIG. 1 used to monitor opening of or removal of a sensor;

FIG. 8 shows a bolt and switch assembly according to another embodiment of the invention;

FIG. 9 shows a bolt and switch assembly according to another embodiment of the invention; and, FIG. 10 shows a bolt and switch assembly according to another embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

A tamper and intrusion detection device for securing a closure comprises a securing element such as a bolt, and a switch assembly. The securing element may be rigid or semi-rigid. The securing element is inserted into an opening of the switch assembly. The securing element may have a threaded end which is received in a threaded hole. The threaded hole which receives the securing element may be located either in a mounting bracket to which the switch assembly is secured, or in a threaded hole in a face plate of the switch assembly. The switch assembly may define an opening and comprise a switch located in the opening. The securing element closes the switch of the switch assembly when the securing element is received in the opening of the switch assembly. The switch assembly is connected to a control circuit which produces a first indication when the switch is closed and a second indication when the switch is open.

The closure may comprise first and second portions which are moveable with respect to each other to open the closure. The securing element may be secured to one portion of the closure and the switch assembly may be secured to the other portion of the closure, such that the closure may not be opened without removing the rigid element from the switch assembly. In situations where the closure comprises locking means, the securing element and the switch assembly need not be secured to the closure, and may be inserted through the locking means and into the opening of the switch assembly, such that the locking means may not be opened without removing the securing element from the switch assembly.

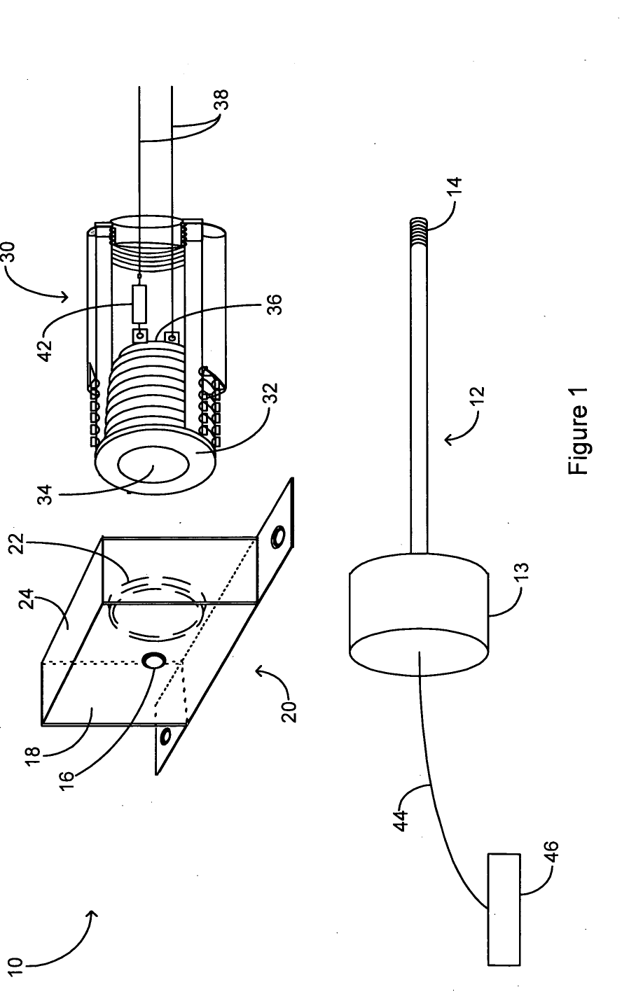

FIG. 1 shows a tamper and intrusion detection device 10 according to one embodiment of the invention. Tamper and intrusion detection device 10 comprises a bolt 12 having an enlarged end 13 and a threaded end 14. Bolt 12 is threadably receivable in a threaded entry hole 16 in a first side 18 of a mounting bracket 20. A switch assembly 30 is threadably receivable in a threaded entry hole 22 in a second side 24 of mounting bracket 20. When bolt 12 and switch assembly 30 are both threadably inserted in mounting bracket 20, threaded end 14 of bolt 12 depresses a momentary switch 32 contained in switch assembly 30.

Momentary switch 32 includes a push-button 34, which closes a contact 36 when depressed. Closure of contact 36 completes a circuit comprising conducting wires 38. Push-button 34 is spring-loaded, and returns to an open (i.e. non-conducting) state when not depressed. When inserted through hole 16 in mounting bracket 20, bolt 12 depresses push-button 34, which allows current to run through conducting wires 38.

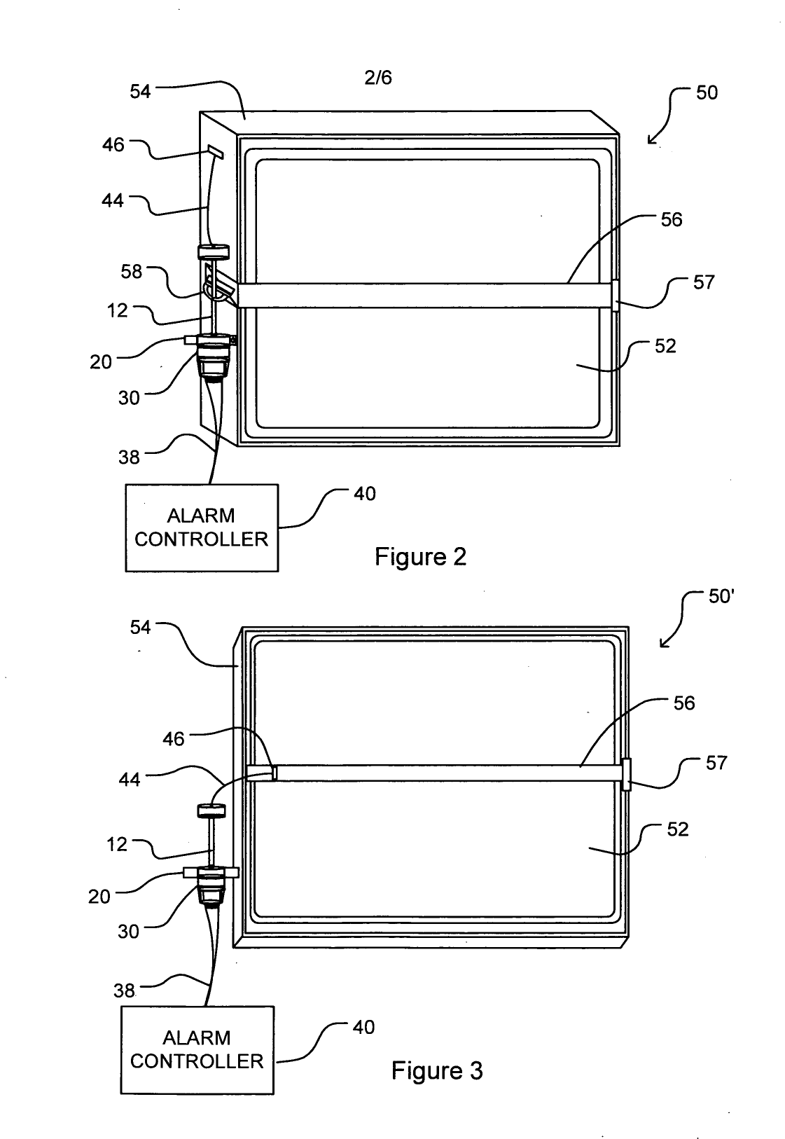

Removal of bolt 12 from switch assembly 30 allows button 34 to return to the open state. Return of push-button 34 to the open state opens contact 36, such that the circuit comprising conducting wires 38 is broken. Breaking of the circuit comprising conducting wires 38 results in the creation of an alarm condition. An alarm condition may be detected by an alarm controller 40 (see FIGS. 2 and 3). Alarm controller may be located, for example, within the closure secured by device 10, or in a vehicle which is used to transport the closure secured by device 10. Alarm controller 40 may, for example, be connected to wires 38. Alternatively, alarm controller 40 may be coupled to wires 38 by means of a wireless transmitter connected to wires 38 and configured to send an alarm signal to alarm controller 40 upon creation of an alarm condition.

Alarm controller 40 may be used to generate a response to the alarm condition, or may create a log recording the alarm condition to alert a user that detection device 10 had been tampered with. Alarm controller 40 may comprise a clock and a location sensor. An alarm condition may result in the activation of, for example and without limitation:

a visual device such as a flashing light or LED;

an audio device such as a siren or other alarm noise-generator;

a paging device that may page an operator to notify the operator of the alarm event; or

a logging device, which may comprise for example an electronic memory which records that an alarm condition has occurred, and optionally the time and/or location at which an alarm condition occurs.

A series resistor 42 may optionally be added to the circuit comprising conducting wires 38. The presence of series resistor 42 makes it difficult, if not impossible, to bypass switch 32 by shorting or disconnecting conducting wires 38 without knowledge of the resistor value. Series resistor 42 may have a variable resistance, to make it even more difficult to bypass switch 32. Resistor 42 may be embedded inside switch assembly 30, so that it is physically inaccessible to a would-be tamperer.

Bolt 12 may be attached to a portion of a closure to be monitored by attachment means. Attachment means may comprise, for example, a metal wire 44 and a metal tab 46 for retaining bolt 12 to the closure to be monitored. Fixation of bolt 12 and mounting bracket 20 to the closure may be required in embodiments where the closure lacks locking means, in order to ensure that the closure being monitored cannot be opened without removing bolt 12 from entry hole 16, thereby resulting in the opening of switch 32.

In some embodiments of the invention, bolt 12 may be covered with paint. Attachment means may also be covered with paint in some embodiments. In one embodiment, the paint is hard and thick to prevent wear through normal use. In another embodiment, the paint loosely bonds to bolt 12, such that the paint is easily removed and must be reapplied periodically. The presence of paint on bolt 12 prevents a would-be thief from cutting bolt 12 and later repairing the cut to make bolt 12 appear undamaged. Bolt 12 may, for example, be painted in a highly visible color to indicate the area to be inspected when the item arrives at a destination point. Such visible coloring possesses a further advantage in that efforts to tamper with bolt 12 will damage the paint, thereby providing the person checking device 10 with an immediate visual indication that bolt 12 has been tampered with.

FIG. 2 shows tamper and intrusion detection device 10 used to secure a hatch 50. Hatch 50 comprises a hatch cover 52 and a frame 54 which form a closure which may accessed by separating cover 52 from frame 54. A latch 56 is attached to frame 54 by a hinge 57, and extends across hatch cover 52 to maintain it in a closed position. A locking ring 58 is affixed to frame 54. The end of latch 56 opposite hinge 57 defines a slot configured to fit over locking ring 58 to hold latch 56 in place.

When hatch 50 is in the locked position, bolt 12 is inserted through locking ring 58 and threadably received in entry hole 16 of mounting bracket 20, such that end 14 depresses button 34 of switch 32. Locking ring 58 maintains latch 56 in the locked position. Hatch 50 cannot be opened without releasing latch 56 from the locked position. Latch 56 cannot be released without removing bolt 12 from locking ring 58. Therefore, hatch 50 is secured in such a manner that it cannot be opened without removing bolt 12 from entry hole 16, thereby resulting in the opening of momentary switch 32 and the creation of an alarm condition as described above. In this configuration, securing means such as wire 44 and tab 46 are optional, and mounting bracket 20 need not be attached to frame 54, since tamper and intrusion detection device 10 must be opened and bolt 12 removed from locking ring before access to hatch 50 is possible, regardless of whether or not device 10 is affixed to hatch 50.

FIG. 3 shows tamper and intrusion detection device 10 used to secure a hatch 50′. Hatch 50′ is similar to hatch 50, except that hatch 50′ lacks a locking ring. Bolt 12 is attached to latch 56 by means of wire 44 and tab 46. Metal tab 46 is welded to latch 56. Metal tab 46 could alternatively be welded directly to the surface of hatch cover 52. Mounting bracket 20 is welded or otherwise non-removably secured to frame 54 of hatch 50′. In this configuration, bolt 12 need not have enlarged end 13, since bolt 12 is secured to latch 56 by wire 44 and tab 46. The positioning of tamper and intrusion detection device 10 is such that hatch 50′ cannot be opened while bolt 12 is threadably received by mounting bracket 20. Hatch 50′ is thereby secured in such a manner that it cannot be opened without removing bolt 12 from entry hole 16, which would result in the opening of momentary switch assembly 32 and the creation of an alarm event as described above.

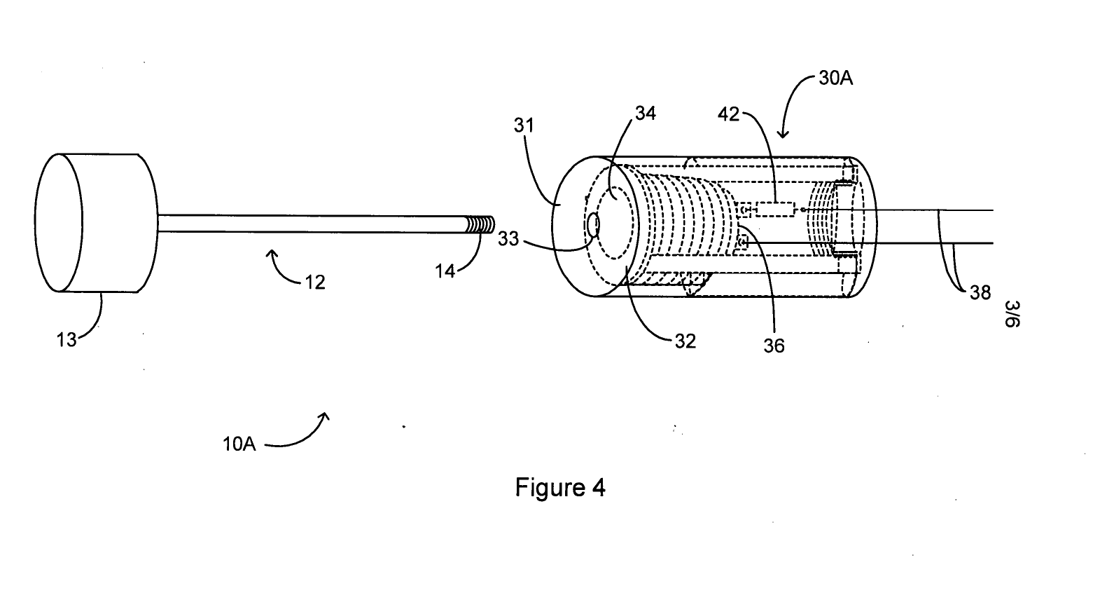

FIG. 4 shows a tamper and intrusion detection device 10A according to another embodiment of the invention. Device 10A is similar to device 10 of FIG. 1, except that device 10 lacks mounting bracket 20, wire 44 and tab 46, and switch assembly 30A comprises a face plate 31 defining a threaded entry hole 33. Device 10A is suitable for securing closures which have locking means, such as for example locking ring 58 of hatch 50 of FIG. 2.

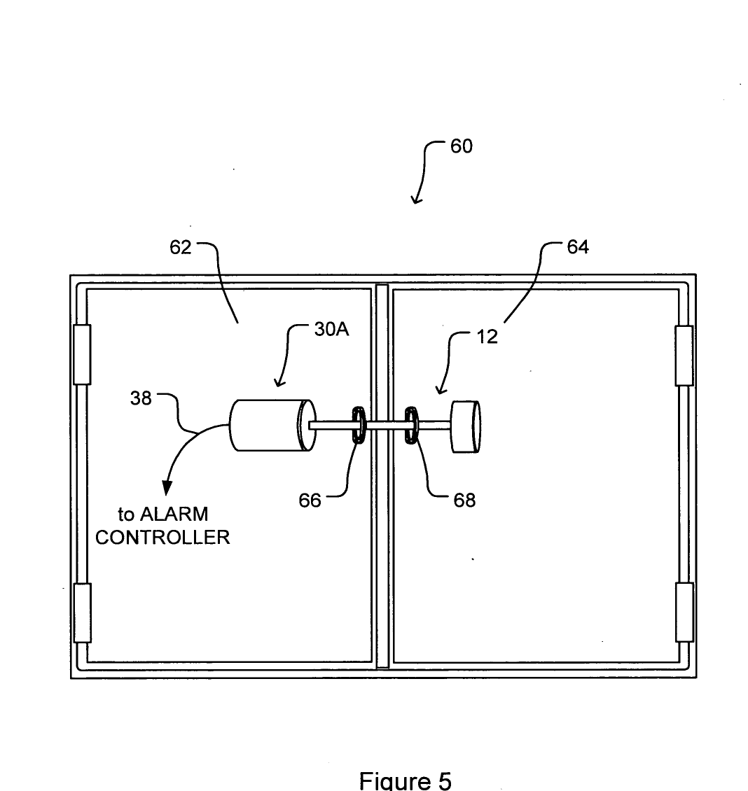

FIG. 5 shows device 10A of FIG. 4 used to secure a container 60 having two adjacent access doors 62 and 64, with their openings located adjacent to one another. Container 60 comprises locking means in the form of two locking rings 66 and 68 positioned on doors 62 and 64 respectively. Bolt 12 is inserted through rings 66 and 68 and threadably received in entry hole 33 of switch assembly 30A, thereby depressing push-button 34. The placement of tamper and intrusion detection device 10A through rings 66 and 68 prevents doors 62 and 64 from being opened without removing bolt 12 from entry hole 33. Removal of bolt 12 from entry hole 33 results in the return of momentary switch 32 to the open position, resulting in the generation of an alarm event as described above.

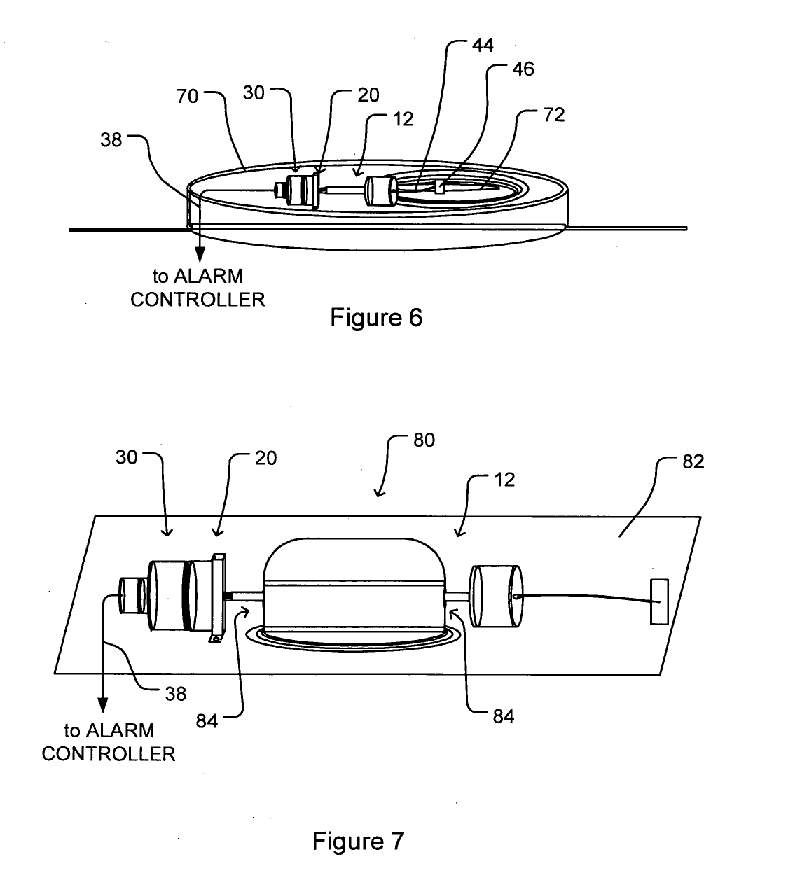

FIG. 6 shows tamper and intrusion detection device 10 of FIG. 1 used to monitor access to a man-hole cover 70. Man-hole cover 70 includes a handle 72 to secure man-hole cover 70 in the closed position, and to aid in opening man-hole cover 70 when required. In this embodiment, bolt 12 is secured to handle 72 by securing wire 44, which is connected to metal tab 46. Metal tab 46 is welded to handle 72. Mounting bracket 20 is secured to man-hole cover 70, for example by welding, and is positioned to threadably receive both switch assembly 30 and bolt 12.

When man-hole cover 70 is closed, bolt 12 may be threadably received in mounting bracket 20 to depress momentary switch 32 in switch assembly 30, as described above. In this embodiment, the positioning of tamper and intrusion detection device 10 is such that removal of handle 72 to open man-hole cover 70 can only be accomplished by detaching bolt 12 from entry hole 16. Removal of bolt 12 from mounting bracket 20 allows momentary switch 32 to return to the open position, thereby resulting in the creation of an alarm event as described above.

FIG. 7 shows tamper and intrusion detection device 10 of FIG. 1 attached to secure a sensor 80. Sensor 80 may, for example, be positioned on a body 82 of a vehicle such as a fuel tanker, in order to monitor fluid levels within a tank of the vehicle. Sensor 80 may comprise, for example, an optical sensor of the type sometimes used on fuel tankers, or may comprise a different type of sensor. Removal of sensor 80 may provide a means for unauthorized persons to access the contents of the vehicle. To monitor access to sensor 80, mounting bracket 20 may be welded to body 82 of the vehicle, and is positioned to threadably receive both switch assembly 30 and bolt 12. Bolt 12 may be secured to body 82 by means of wire 44 connected to metal tab 46, which is in turn welded to body 82.

To monitor tampering with sensor 80, bolt 12 is passed through an opening 84 through sensor 80, and is threadably received in entry hole 16 of mounting bracket 20. Because of the positioning of bolt 12 and switch assembly 30, sensor 80 cannot be removed to access the contents of the tank without removal of bolt 12 from entry hole 16 of mounting bracket 20. Removal of bolt 12 from mounting bracket 20 allows momentary switch 32 to return to the open position, thereby resulting in the creation of an alarm event as described above.

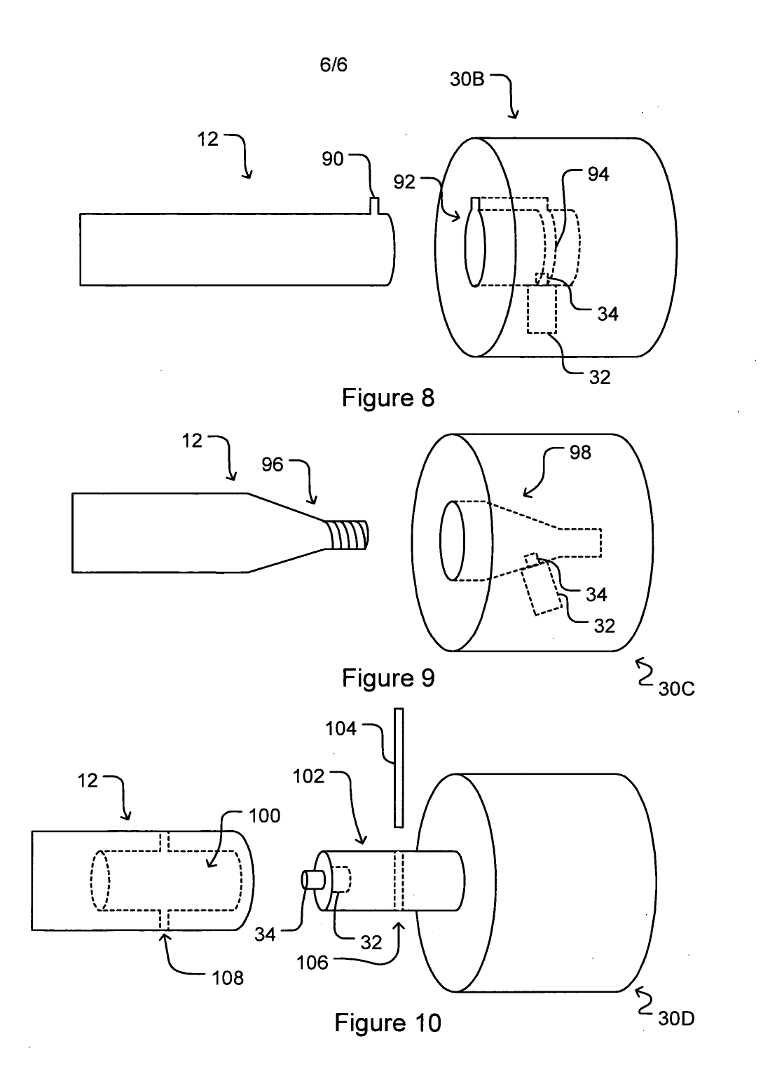

FIG. 8 shows bolt 12 and a switch assembly 30B according to another embodiment of the invention. In the FIG. 8 embodiment, bolt 12 comprises a protrusion 90 near an end thereof. Switch assembly 30B defines a notched opening 92 configured to receive bolt 12 and protrusion 90. A groove 94 is provided so that bolt 12 may be turned after being inserted into opening 92, and protrusion 90 may move within groove 94, thereby retaining bolt 12 in switch assembly 30B. Switch 32 is positioned such that button 34 is depressed by protrusion 90 when bolt 12 is inserted into opening 92 and turned.

FIG. 9 shows bolt 12 and a switch assembly 30C according to another embodiment of the invention. In the FIG. 9 embodiment, bolt 12 comprises a tapered end 96 with a threaded portion thereon. Switch assembly 30C defines a tapered opening 98 configured to threadably receive tapered end 96 of bolt 12. Switch 32 is positioned such that button 34 is depressed by tapered end 96 when bolt 12 is inserted into opening 98.

FIG. 10 shows bolt 12 and a switch assembly 30D according to another embodiment of the invention. In the FIG. 10 embodiment, bolt 12 defines an opening 100 therein. Switch assembly 30D does not have an opening, but instead comprises a protrusion 102 configured to be received in opening 100. Switch 32 is positioned at the end or protrusion 102 such that button 34 is depressed by bolt 12 when opening 100 receives protrusion 102. A pin 104 is provided to be inserted through holes 106 and 108 in protrusion 102 and bolt 12, respectively, to retain protrusion 102 in opening 100. It is to be understood that a similar pin and corresponding holes could be used to retain bolt 12 in any of the configurations of the switch assemblies described herein.

While a number of exemplary aspects and embodiments have been discussed above, those of skill in the art will recognize certain modifications, permutations, additions and sub-combinations thereof. For example, the switch 32 could comprise a potentiometer adapted to have a resistance which varies in response to insertion of bolt 12 into opening 34, and wires 38 could be connected to an analog voltage detector adapted to produce a signal indicative of the extent to which bolt 12 is within opening 34.

It is therefore intended that the following appended claims and claims hereafter introduced are interpreted to include all such modifications, permutations, additions and sub-combinations as are within their true spirit and scope.

What is claimed is:

1. A device for monitoring opening of a closure, the device comprising:
a securing element; and
a switch assembly including a switch and an opening positioned to receive the securing element, the switch configured to be in a first position when the securing element is inserted into the opening and in a second position when the securing element is not inserted into the opening,
whereby the closure cannot be opened while the securing element is within the opening of the switch assembly.

2. A device according to claim 1 further comprising a control circuit coupled to the switch assembly and configured to produce a first indication when the switch is in the first position and to produce a second indication when the switch is in the second position.

3. A device according to claim 1 wherein the securing element comprises a bolt having a threaded end.

4. A device according to claim 3 wherein the switch assembly comprises a threaded portion, the device further comprising a mounting bracket defining a first threaded entry hole on one side thereof for receiving the threaded end of the bolt, and a second threaded entry hole on an opposite side thereof for receiving the threaded portion of the switch assembly.

5. A device according to claim 3 wherein the switch assembly comprises a face plate defining a threaded entry hole therethough for receiving the threaded end of the bolt, the threaded entry hole positioned adjacent the opening of the switch assembly.

6. A device according to claim 3 wherein the securing element comprises attachment means for attaching the bolt to the closure.

7. A device according to claim 6 wherein the attachment means comprises a wire secured between the bolt and the closure.

8. A device according to claim 3 wherein the bolt is covered with paint.

9. A device according to claim 8 wherein the paint is thick and hard to prevent wear.

10. A device according to claim 8 wherein the paint is easily removable from the bolt.

11. A device according to claim 2 wherein the control circuit is configured so that the second indication results in one or more of the activation of a visual device, the activation of an audio device, the activation of a paging device, and the activation of a logging device to record the alarm event.

12. A device according to claim 1 further comprising means for retaining the securing element in the opening of the switch assembly.

13. A device according to claim 12 wherein the means for retaining the securing element comprises a threaded portion at an end of the securing element, and a threaded hole positioned adjacent the opening of the switch assembly.

14. A device according to claim 12 wherein the means for retaining the securing element comprises a protrusion near an end of the securing element, and a groove positioned withing the opening of the switch assembly and configured to receive the protrusion.

15. A device according to claim 12 wherein the means for retaining the securing element comprises a pin insertable through holes through the switch assembly and the securing element.

16. A device for monitoring opening of a closure, the device comprising:
a securing element having an opening defined in an end thereof; and
a switch assembly comprising a protrusion and a switch at an end of the protrusion, the protrusion configured to be receivable in the opening of the securing element, the switch configured to be in a first position when the protrusion is inserted into the opening of the securing element and in a second position when the protrusion is not inserted into the opening of the securing element,
whereby the closure cannot be opened while the protrusion of the switch assembly is within the opening of the securing element.

17. A method for monitoring opening of a closure having first and second portions which are moveable with respect to one another to allow opening of the closure, the method comprising:
providing a device comprising a securing element and a switch assembly including a switch and an opening positioned to receive the securing element, the switch configured to be in a first position when the securing element is inserted into the opening and in a second position when the securing element is not inserted into the opening;
attaching the securing element to the first portion of the closure;
attaching the switch assembly to the second portion of the closure; and
inserting the securing element into the opening of the switch assembly,
whereby the closure cannot be accessed without removing the securing element from the opening of the switch assembly.

18. A method according to claim 17 wherein removing the securing element creates an alarm condition.

19. A method according to claim 18 where the alarm condition comprises activating a visual device.

20. A method according to claim 18 where the alarm condition comprises activating an audio device.

21. A method according to claim 18 where the alarm condition comprises activating a paging device.

22. A method according to claim 18 where the alarm condition comprises activating a logging device to record the removal of the securing element.

23. A method for monitoring opening of a closure having first and second portions which are moveable with respect to one another to allow opening of the closure, and locking means for holding the first and second portions of the closure in a closed position, the method comprising:
providing a device comprising a securing element and a switch assembly including a switch and an opening positioned to receive the securing element, the switch configured to be in a first position when the securing element is inserted into the opening and in a second position when the securing element is not inserted into the opening; and
inserting the securing element through the locking means and into the opening of the switch assembly,
whereby the closure cannot be accessed without removing the securing element from the opening of the switch assembly.

24. A method of monitoring access to a tank having a sensor positioned over an access to the tank, the method comprising:
providing a device comprising a securing element and a switch assembly including a switch and an opening positioned to receive the securing element, the switch configured to be in a first position when the securing element is inserted into the opening and in a second position when the securing element is not inserted into the opening;
attaching the switch assembly to the tank near the sensor; and
inserting the securing element through an opening in the sensor and into the opening of the switch assembly,
whereby the sensor cannot be removed from the access to the tank without removing the securing element from the opening of the switch assembly.
